(19) United States
(12) Patent Application Publication
(10) Pub. No.: US 2020/0184475 A1
(43) Pub. Date: Jun. 11, 2020

(54) DATA AGGREGATION SERVICES FOR PAYMENT CARDS

(71) Applicant: Mastercard International Incorporated, Purchase, NY (US)

(72) Inventors: James Patrick Kelly, Stamford, CT (US); Kyle T. Williams, Wentzville, MO (US); David J. Senci, Troy, IL (US)

(73) Assignee: Mastercard International Incorporated, Purchase, NY (US)

(21) Appl. No.: 16/212,828

(22) Filed: Dec. 7, 2018

(51) Int. Cl. G06Q 20/40

(52) U.S. Cl. CPC G06Q 20/409; G06Q 20/4016; G06Q 20/4018

(57) ABSTRACT

Systems and methods for verifying the current status of a payment card are provided that may efficiently aggregate and distribute non-visible information regarding a recovered payment card. More particularly, the systems and computer-implemented methods of the present invention permit the efficient aggregation of the non-visible payment account data associated with a payment card and the distribution of such data to investigators in possession of the card. Such systems and methods for verifying a payment card typically involve: (a) aggregating payment account data associated with the payment card in an aggregated data storage site; (b) obtaining visible verification data associated with the payment card from an investigator; (c) verifying the visible verification data associated with the payment card; (d) retrieving the payment account data from the aggregated data storage site; and (e) submitting the payment account data to the investigator.

### BACKGROUND

### 1. Field of the Invention

The present disclosure is related to systems and methods for verifying the current status of a payment card. More particularly, the present disclosure is related to systems and methods for aggregating and collecting data associated with a payment card.

### 2. Description of the Related Art

The use of payment cards, such as credit cards and debit cards, for payment transactions is now commonplace. Unfortunately, criminals may illegally obtain one or more payment cards in order to conduct fraudulent payment transactions with the cards. Such stolen cards are often recovered or seized by authorities before or after such fraudulent payment transactions occur. In such scenarios, the individual or group recovering the payment cards only have the visible information on the cards themselves (e.g., card number, CVC, and expiration date) and may need to quickly obtain additional information about the recovered cards in order to complete their investigation, such as the last locations the cards were used, if the cards are listed as lost and/or stolen, and the most recent devices the cards are associated with. In order to obtain this additional information, the investigators have to make multiple manual requests to multiple entities to provide this additional information, which may take days or weeks since this information can only be obtained from different sources. Therefore, obtaining additional, non-visible information regarding recovered payment cards can be quite inefficient and time-consuming.

### SUMMARY

One or more embodiments of the present invention generally concern a computer-implemented method for authenticating the current status of a payment card. Generally, the method comprises the steps of: (a) aggregating payment account data associated with the payment card in an aggregated data storage site, wherein the payment account data comprises at least three data types selected from the group consisting of recent financial transaction data, legal status data, breach analysis data, common device data associated with the payment card, and recent device data associated with the payment card; (b) obtaining visible verification data associated with the payment card from an investigator; (c) verifying the visible verification data associated with the payment card; (d) retrieving the payment account data from the aggregated data storage site; and (e) submitting the payment account data to the investigator.

One or more embodiments of the present invention may also concern a payment card verification system for a payment network. Generally, the payment card verification system comprises: (a) a memory device for storing data and (b) a processor communicatively coupled to the memory device. The processor may be programmed to: (i) aggregate payment account data associated with a payment card in an aggregated data storage site, wherein the payment account data comprises at least three data types selected from the group consisting of recent financial transaction data, legal status data, breach analysis data, common device data associated with the payment card, and recent device data associated with the payment card; (ii) obtain visible verification data associated with the payment card from an investigator; (iii) verify the visible verification data associated with the payment card; (iv) retrieve the payment account data from the aggregated data storage site; and (v) submit the payment account data to the investigator.

One or more embodiments of the present invention may also concern a non-transitory computer-readable storage media having computer-executable instructions for verifying a payment card stored thereon. Generally, when executed by at least one processor, the computer-executable instructions cause the processor to: (a) aggregate payment account data associated with a payment card in an aggregated data storage site, wherein the payment account data comprises at least three data types selected from the group consisting of recent financial transaction data, legal status data, breach analysis data, common device data associated with the payment card, and recent device data associated with the payment card; (b) obtain visible verification data associated with the payment card from an investigator; (c) verify the visible verification data associated with the payment card; (d) retrieve the payment account data from the aggregated data storage site; and (e) submit the payment account data to the investigator.

### BRIEF DESCRIPTION OF THE FIGURES

Embodiments of the present invention are described herein with reference to the following drawing figures, wherein:

FIG. 1 is a block diagram of an exemplary multi-party payment network system having a payment card verification module (“PCV module”) according to embodiments of the present invention;

FIG. 2 is another block diagram of an exemplary payment card network system, such as the payment card network system shown in FIG. 1, including a plurality of client computing systems connected to a server system of an interchange network, and with the PCV module from FIG. 1 illustrated in association with the server system;

FIG. 3 illustrates an exemplary configuration of the server system shown in FIG. 2;

FIG. 4 illustrates an exemplary configuration of a client computing system from FIG. 2; and

FIG. 5 is a flow chart depicting an exemplary method that may be implemented in the system of FIG. 1 for authenticating the current status of a payment card.

### DETAILED DESCRIPTION

The following detailed description of the present invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. However, the scope of the present invention is defined only by the appended claims, along with the full scope of equivalents to which such claims are entitled.

Broadly characterized, the present invention relates to systems and methods for verifying the current status of a payment card. More particularly, the disclosed embodiments provide systems and computer-implemented methods for aggregating and collecting additional data associated with a payment card. For instance, the systems and computer-implemented methods of the present invention permit the efficient aggregation of the non-visible payment account data associated with a payment card and the distribution of such data to investigators in possession of the card. Unlike previous systems, which must piecemeal this additional information together from various sources, the systems of the present invention are able to aggregate and store this data at a single source and efficiently distribute the data as necessary to an investigator looking into the validity and background of a payment card.

In one or more embodiments, the disclosed embodiments provide systems and methods for verifying a payment card that involves: (a) aggregating payment account data associated with the payment card in an aggregated data storage site; (b) obtaining visible verification data associated with the payment card from an investigator; (c) verifying the visible verification data associated with the payment card; (d) retrieving the payment account data from the aggregated data storage site; and (e) submitting the payment account data to the investigator.

The payment account data that is aggregated at the aggregated data storage site may comprise any number of data types selected from the group consisting of recent financial transaction data associated with the payment card, legal status data of the payment card, breach analysis data of the payment card, common device data associated with the payment card, and recent device data associated with the payment card. In certain embodiments, the payment account data that is aggregated at the aggregated data storage site comprises recent financial transaction data associated with the payment card, legal status data of the payment card, breach analysis data of the payment card, common device data associated with the payment card, and recent device data associated with the payment card.

In one or more embodiments, the recent financial transaction data associated with the payment card can comprise a listing of any number of the previous financial transactions involving the payment card. For example, the financial transaction data can include the geographical location, time and date, and merchant name of the previous 2-10 financial transactions involving the payment card.

In one or more embodiments, the legal status data indicates whether the payment card has been listed as stolen or lost.

In one or more embodiments, the breach analysis data indicates whether the payment card has been involved in an account data compromise breach. For example, this data may indicate whether the possessed payment card was involved in a data breach of a specific merchant.

In one or more embodiments, the common device data indicates a payment device most frequently used with the payment card. For instance, this common device data may indicate the specific device that is most commonly used with the payment card.

In one or more embodiments, the most recent device data indicates the type of payment device that was most recently used with the payment card.

As discussed in further detail below, the payment account data may be aggregated and stored at the aggregated data storage site by a payment card verification module (“PCV module”).

Additionally, in certain embodiments, the PCV module may also obtain the visible verification data associated with the payment card from an investigator and verify whether this visible verification data is authentic. If the visible verification data is verified and deemed authentic, then the PCV module may submit the payment account data to the investigator in possession of the payment card.

As used herein, “investigator” may refer to any person or entity that is in possession of the payment card and is looking to obtain additional information on the payment card beyond the visible verification data on the payment card. The investigator may include, for example, a merchant or a government official, such as a police officer.

The visible verification data on the payment card provided by the investigator can comprise at least one, but preferably several, data type(s) selected from the group consisting of a card number associated with the payment card, an expiration date associated with the payment card, a card verification code (“CVC”) associated with the payment card, and a cardholder's name associated with the payment card. In one or more embodiments, the visible verification data provided by the investigator can comprise a card number associated with the payment card, an expiration date associated with the payment card, and a CVC associated with the payment card. As used herein, the CVC may also be referred to as the card verification value (“CVV”). As would be appreciated by one skilled in the art, the terms CVC and CVV may be used interchangeably.

In one or more embodiments, the investigator may input the visible verification data into an application programming interface (“API”), which is in communication with the PCV module. For example, the investigator may input the visible verification data into an API application, such as an application connected to a payment network, that allows the visible verification data to be transmitted to and reviewed by the PCV module. Upon receiving the visible verification data from the investigator, the PCV module will first verify that the visible verification data refers to a valid payment account. If the visible verification data corresponds to a valid payment account, then the PCV module can submit the additional payment account data to the investigator via the API application, which has been aggregated at the aggregated data storage site by the PCV module. Alternatively, if the visible verification data does not correspond to a valid payment account, then the PCV module can send a reply to the investigator via the API application indicating that the visible verification data, such as the card number, is not linked to a valid payment account.

The disclosed systems and methods of the present invention may be utilized with one or more payment cards. For instance, the disclosed systems and methods of the present invention may be utilized by an investigator to investigate a plurality of payment cards.

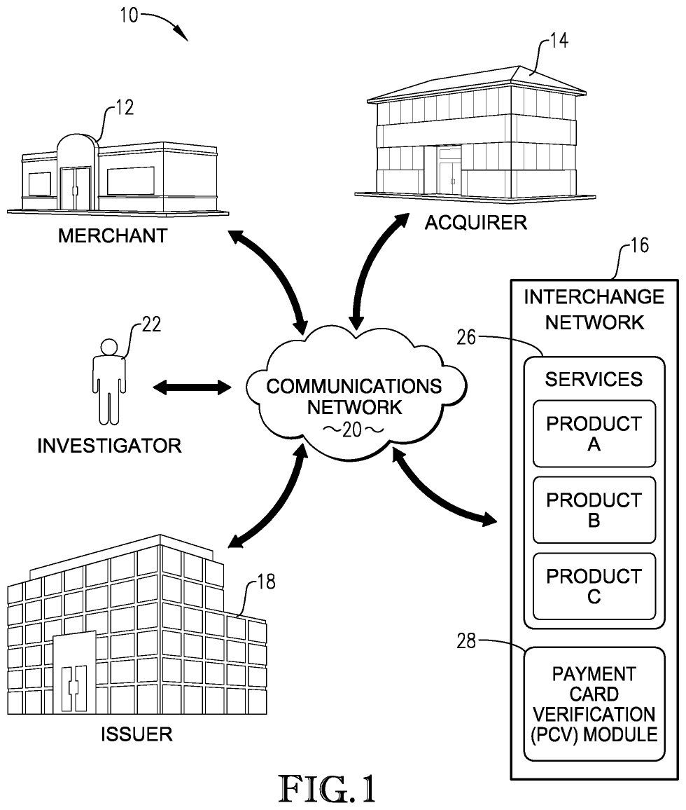

An exemplary system for implementing embodiments of the present invention will now be described with reference to FIG. 1, a block diagram of an exemplary multi-party payment network system 10. In general, the payment network system 10 is configured to enable payment transactions, such as payment-by-card transactions, through operation of a number of interconnected parties, including merchants 12, acquirers 14, interchange networks 16, and/or card issuers 18. Embodiments described herein may relate to a payment network system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. Mastercard is a registered trademark of Mastercard International Incorporated located in Purchase, N.Y.

In the exemplary embodiment of FIG. 1, the payment network system 10 may generally include the merchant 12, the acquirer 14, the interchange network 16, and the issuer 18, coupled in communication via a communications network 20. As such, an investigator 22 (e.g., a merchant, a federal authority, or a police officer), who is in possession of a payment card, can initiate an investigation of the payment card over the payment network system 10 in order to verify that the payment card is valid and obtain additional information on the payment card. The communications network 20 used to interconnect the parties of the payment network system 10 may include various types of networks, such as one or more of a local area network (LAN), a wide area network (WAN) (e.g., the internet, etc.), a mobile network, a virtual network, and/or any other suitable public and/or private network capable of facilitating communication among the merchant 12, the acquirer 14, the interchange network 16, the issuer 18, and the investigator 22. In some embodiments, the communications network 20 may include more than one type of network, such as a private payment transaction network provided by the interchange network 16 to the acquirers 14 and the issuers 18 and, separately, the public internet, which may facilitate communication between the merchants 12 and (1) the interchange network 16, (2) the acquirers 14, and/or (3) the investigator 22.

In typical systems, a financial institution, referred to as an “issuing bank” or the issuer 18, issues a payment card, such as a credit or debit card, to a cardholder, who uses the payment card to tender payment for purchases made from a merchant 12. Merchants 12 are typically associated with products, for example, and without limitation, goods and/or services, that are offered for sale and are sold to the cardholder. The merchant 12 may include, for example, a physical location and/or a virtual location. A physical location includes, for example, a brick-and-mortar store, etc., and a virtual location includes, for example, an internet-based store-front.

To accept payment with the payment card, the merchant 12 generally has established an account with a financial institution that is part of the payment network system 10. This financial institution is generally referred to as a “merchant bank,” an “acquiring bank,” or the acquirer 14. When the cardholder tenders payment for a purchase with a payment card, the merchant 12 requests authorization from the acquirer 14 for the amount of the purchase. The request may be performed over the telephone, but is usually performed through the use of a computing device, such as a point-of-sale terminal, that reads the cardholder's account information from a magnetic stripe, a chip, or embossed characters on the payment card and generates a transaction message, in the form of an authorization request, which is communicated electronically to transaction processing computers of the acquirer 14. Alternatively, the acquirer 14 may authorize a third party to perform transaction processing on its behalf. In such cases, the merchant's 12 point-of-sale terminal will be configured to communicate with the third party. Such a third party is generally referred to as a “merchant processor,” an “acquiring processor,” or a “third-party processor.”

Using the interchange network 16, computing devices of the acquirer 14 or merchant processor can communicate with computing devices of the issuer 18 to determine whether the cardholder's account is in good standing and whether the purchase is covered by the cardholder's available credit line or account balance. Again, such communication generally involves the interchange network 16 providing the transaction message to the issuer 18, such that the issuer 18 can verify that the cardholder's account has sufficient funds to cover the payment transaction. Based on these determinations, the payment transaction can be declined or accepted. Specifically, the issuer 18 can generate a transaction message, in the form of an authorization response, which indicates whether the payment transaction should be declined or accepted. The transaction message can be sent from the issuer 18, via the interchange network 16 and/or the acquirer 14, to the merchant 12 such that the cardholder can be informed as to whether the payment transaction is declined or accepted.

After a purchase has been made, a clearing process occurs to transfer additional financial transaction data related to the purchase transaction among the parties of the payment network system 10, such as the acquirer 14, the interchange network 16, and the issuer 18. More specifically, during and/or after the clearing process, additional financial transaction data, such as a time of purchase, a merchant name, a type of merchant, purchase information, cardholder account information, a type of transaction, itinerary information, information regarding the purchased item and/or service, and/or other suitable information, may be associated with the payment transaction and transmitted between parties to the payment transaction, and may be stored (e.g., in databases) by any of the parties.

After a payment transaction is authorized and cleared, the payment transaction is settled among the merchant 12, the acquirer 14, and the issuer 18. Settlement refers to the transfer of financial transaction data and/or funds among the merchant's 12 account, the acquirer 14, and the issuer 18 related to the transaction. Usually, payment transactions are captured and accumulated into a “batch,” which is settled as a group. More specifically, a payment transaction is typically settled between the issuer 18 and the interchange network 16, then between the interchange network 16 and the acquirer 14, and then between the acquirer 14 and the merchant 12.

With continued reference to FIG. 1, the interchange network 16 is generally used to facilitate communication and financial transaction data processing between the parties of the payment network system 10. In addition, the interchange network 16 may be configured to offer or provide one or more services 26 (e.g., Product A, Product B, Product C, etc.) to one or more of its clients, which may include the merchants 12, the acquirer 14, the issuer 18, the cardholder, and/or the investigator 22. The services may be referred to as value-added services 26, for example, in that the services are often provided in addition to the standard interchange network 16 goal of coordinating payment transactions initiated by the cardholders. Exemplary services include, for example and without limitation, fraud services (e.g., fraud detection, fraud scoring, etc.), loyalty services (e.g., managing reward points, etc.), account control services (e.g., transaction limits, etc.), authentication services, routing intelligence services, message transformation services (e.g., format and/or standard conversions, etc.), services for applying additional derived data and/or insights to transaction messages, identification of other value added services to be applied, etc.

Embodiments of the present invention provide for the interchange network 16 to be configured to offer or provide a specific value-added service 26, in the form of a payment card verification and research service, which can be used by an investigator 22 to: (1) verify that possessed payment cards are valid and (2) obtain additional, non-visible information regarding the payment cards. This investigative service for researching and verifying possessed payment cards may be implemented by a payment card verification (PCV) module 28, which is illustrated schematically as part of the interchange network 16 of FIG. 1. The PCV module 28 may be configured as a specially-programmed computer system that enables the interchange network 16 to implement an automated process or routine to: (1) aggregate non-visible payment account data associated with a payment card in an aggregated data storage site, (2) obtain visible verification data associated with the payment card from an investigator via an API application, (3) analyze and verify whether the visible verification data is associated with a valid payment card and account, and (4) transmit the aggregated payment account data associated with the payment card to the investigator via the API application if the visible verification data is associated with a valid payment account.

Based on the PCV module's 28 analyses of the visible verification data provided by the investigator 22, the PCV module 28 may submit the additional payment account data associated with the payment card to the investigator 22. As will be described in more detail below, the PCV module 28 may comprise a computing device in the form of one or more processing elements communicatively coupled with one or memory elements with a computer program stored thereon (e.g., a computer-readable storage media or medium comprising a non-transitory medium with an executable computer program stored thereon), such that the PCV module 28 can be specially programmed to: (1) aggregate non-visible payment account data associated with a payment card in an aggregated data storage site, (2) obtain visible verification data associated with the payment card from an investigator via an API application, (3) analyze and verify whether the visible verification data is associated with a valid payment card and account, and (4) transmit the aggregated payment account data associated with the payment card to the investigator 22 via the API application if the visible verification data is associated with a valid payment account.

As noted above, the investigator 22 can be linked to the communications network 20 via an API application. The type of API application is not limited and may include, for example, a web-based system, a computer operating system, a mobile device application, or any other digitally-based program that allows an investigator to input visible verification data from a payment card and receive an output from the PCV module 28 that contains the additional payment account data noted above.

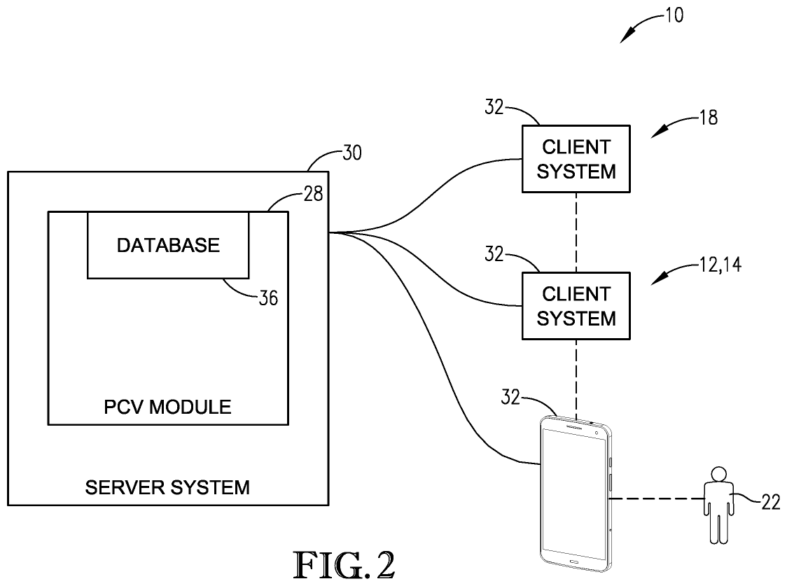

FIG. 2 is another simplified block diagram of the exemplary payment network system 10. The block diagram of FIG. 2 may be considered an alternate description of the components of the payment network system 10 described above. The payment network system 10 of FIG. 2 includes a plurality of computing devices such as, for example, the PCV module 28, a server system 30, and one or more client systems 32 all connected via a communications network, such as the internet. The server system 30 may comprise a server-type computing device of the interchange network 16, which is particularly configured to perform various functions and features described herein on behalf of the interchange network 16. Similarly, the PCV module 28 may comprise a computing device of the interchange network 16, which is particularly configured to: (1) aggregate non-visible payment account data associated with a payment card in an aggregated data storage site, (2) obtain visible verification data associated with the payment card from an investigator via an API application, (3) analyze and verify whether the visible verification data is associated with a valid payment card and account, and (4) transmit the aggregated payment account data associated with the payment card to the investigator 22 via the API application if the visible verification data is associated with a valid payment account. In some embodiments, the PCV module 28 may be incorporated within the server system 30. In alternate embodiments, the PCV module 28 may be separate from the server system 30. In contrast, the client systems 32 may be computing devices of clients, such as the merchant 12, the acquirer 14, the issuer 18, and/or the investigator 22, which are in communication with the server system 30 via the communications network. It is noted that the payment network system 10 may include more, fewer, or alternative components and/or perform more, fewer, or alternative actions, including those discussed elsewhere herein.

In more detail, the server system 30 may be associated with the interchange network 16 and may be referred to as an interchange computer system. Broadly, the server system 30 may be used for processing data associated with payment transactions and payment accounts. In some embodiments, the server system 30 may include, or otherwise be associated with a database 36, which is configured to store information about a variety of matters, such as may be necessary for processing financial transaction data. In some embodiments, the database 36 may comprise a centralized database stored on the server system 30. In some embodiments, the database 36 may be associated with the PCV module 28. In an alternative embodiment, the database 36 may be stored remotely from the server system 30 and/or the PCV module 28, such as in the form of a distributed or non-centralized database. In one exemplary embodiment, the database 36 may include a single database having separated sections or partitions or may include multiple databases, each being separate from each other. In some embodiments, for example, where the database 36 includes separate sections, partitions, or multiple databases, the database 36 may be configured to store financial transaction data generated as part of payment transactions conducted over the payment network system 10 including data relating to cardholders, issuers 18, acquirers 14, and/or payment transactions. In certain embodiments, the database 36 may serve as the aggregated data storage site, where the PCV module 28 may aggregate and store the above-referenced payment account data associated with a payment card.

Returning to FIG. 2, the client systems 32 may include various computer systems associated with the merchant 12 and/or acquirer 14 (shown in FIG. 1), as well as the issuer 18 (also shown in FIG. 1). Another client system 32 may be a computing device associated with an investigator 22. It should be understood, however, the client systems 32 may be computer systems associated with other entities, such as online banks, bill payment outsourcers, processors, billers, merchants, government officials, or another entity associated with the payment network system 10.

As depicted in FIG. 2, the investigator 22 can interact with the PCV module 28 through the use of a client system 32, which can be in the form of a mobile device (e.g., a smartphone, mobile phone, a table, a laptop, PDA, etc.). The investigator 22 can provide the visible verification data associated with a possessed payment card with this mobile device and the PCV module 28 may verify the authenticity of the visible verification data and, if such data is deemed authentic and associated with a valid payment account, submit the aggregated payment account data to the investigator 32 via this mobile device.

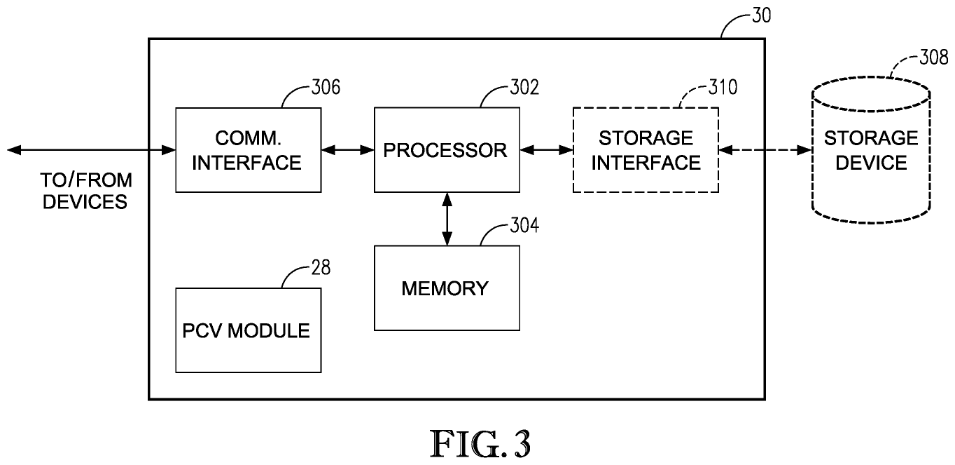

FIG. 3 illustrates an exemplary configuration of the server system 30 in more detail. In the exemplary embodiment, the server system 30 may include, for example, and without limitation, the server 30 and the PCV module 28. The server system 30 may additionally include one or more processors 302 for executing instructions, processes, code segments, routines, or the like, which may be stored in a memory 304. The processor 302 may include one or more processing units (e.g., in a multi-core configuration) for executing instructions. The instructions may be executed within a variety of different operating systems on the server system 30, such as UNIX, LINUX, Microsoft Windows®, etc. It should also be appreciated that upon initiation of a computer-implemented method, various instructions may be executed during initialization. Some operations may be required in order to perform one or more processes described herein, while other operations may be more general and/or specific to a particular programming language (e.g., C, C#, C++, Java, or other suitable programming languages, etc.).

The memory 304 of the server system 30 may be communicatively coupled with the processor 302 and may include, for example, and without limitation, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only and are thus not limiting as to the types of memory usable for storage of a computer program.

The processor 302 may be operatively coupled to a communication interface 306 such that the server system 30 is capable of communicating with a remote device, such as a client system 32 or another server system 30. For example, the communication interface 306 may communicate with the client systems 32 via the internet. The processor 302 may also be operatively coupled to a storage device 308. The storage device 308 may comprise any computer-operated hardware suitable for storing and/or retrieving data. In certain embodiments, the storage device 308 may provide or make available the database 36, described above, which can be used by the sever system 30. In some embodiments, the storage device 308 may be integrated in the server system 30 and/or in the PCV module 28. For example, the server system 30 may include one or more hard disk drives that comprise the storage device 308. In other embodiments, the storage device 308 may be external to the server system 30 and may be accessed by the server systems 30 via a storage interface 310 described in more detail below. The storage device 308 may include multiple storage units such as hard disks or solid-state disks in a redundant array of inexpensive disks (RAID) configuration. The storage device 308 may include a storage area network (SAN) and/or a network attached storage (NAS) system.

As noted, the processor 302 may be operatively coupled to the storage device 308 via the storage interface 310. The storage interface 310 may comprise any component capable of providing the processor 302 with access to the storage device 308. The storage interface 310 may include, for example, and without limitation, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 308.

Embodiments provide for the PCV module 28 to be a component of the server system 30 or, alternatively, to be a separate computing device. As such, the PCV module 28 can be used to perform routines for: (1) aggregating payment account data associated with a payment card in an aggregated data storage site, (2) obtaining visible verification data associated with the payment card from an investigator, (3) verifying the visible verification data associated with the payment card, (4) retrieving the payment account data from the aggregated data storage site, and (5) submitting the payment account data to the investigator. In embodiments in which the PCV module 28 is incorporated within the server system 30, the PCV module 28 may be a specifically-programmed section of the server system 30. As such, the PCV module 28 may use the processor 302, the memory 304, the communications interface 306, and/or the storage device 308 of the server system 30. In alternate embodiments, the PCV module 28 may be a separate computing device (which may be communicatively coupled with) the server system 30. In such embodiments, the PCV module 28 may include its own processor, memory, communications interface, and/or the storage device, similar to those components described above with respect to the server system 30. In such embodiments, for example, the PCV module 28 may be independently associated with the interchange network 16 or with an outside third party in a contractual relationship with the interchange network 16.

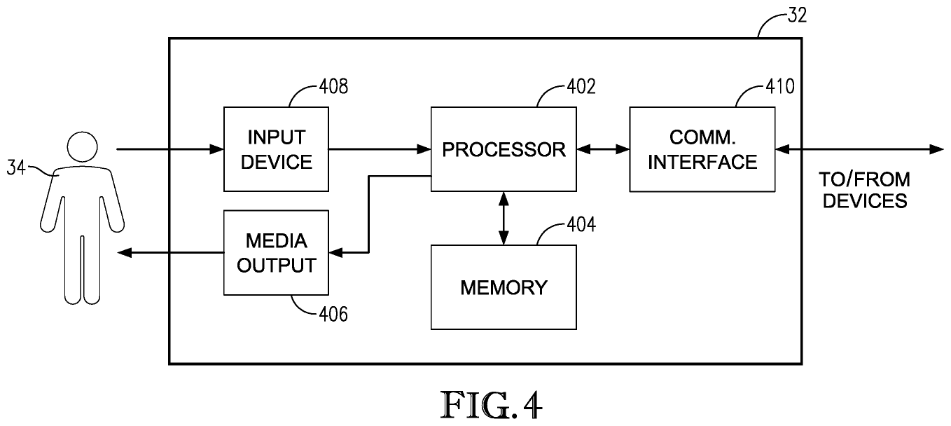

FIG. 4 illustrates an exemplary configuration of a client system 32. In the example embodiment, the client system 32 may include one or more processors 402 for executing instructions, processes, code segments, routines, or the like, which may be stored in a memory 404. The processor 402 may include one or more processing units, for example, a multi-core configuration. The memory 404 is any device allowing information such as executable instructions and/or other data to be stored and retrieved. The memory 404 may include one or more computer readable media.

The client system 32 may also include at least one media output component 406 for presenting information to users, such as investigators. The media output component 406 is any component capable of conveying information to an authorized user 34 (e.g., indications that the visible verification data does or does not correspond to a valid payment account, aggregated payment account data associated with a possessed payment card, etc.). In some embodiments, the media output component 406 includes an output adapter such as a video adapter and/or an audio adapter. An output adapter is operatively coupled to the processor 402 and operatively couplable to an output device such as a display device, a liquid crystal display (LCD), organic light emitting diode (OLED) display, “electronic ink” display, an audio output device, a speaker, or headphones.

In some embodiments, the client system 32 includes an input device 408 for receiving input from the user 34, such as an investigator. The input device 408 may include, for example, a keyboard, a pointing device, a mouse, a stylus, a touch sensitive panel, a touch pad, a touch screen, a gyroscope, an accelerometer, a camera, a position detector, or an audio input device. For example, the input device 408 can be used by the user 34 to input the visible verification data from a possessed payment card.

A single component such as a touch screen may function as both an output device of the media output component 406 and the input device 408. The client system 32 may also include a communication interface 410, which is communicatively couplable to a remote device such as the server system 30. The communication interface 410 may include, for example, a wired or wireless network adapter or a wireless data transceiver for use with a mobile phone network, Global System for Mobile communications (GSM), 3G, 4G, Bluetooth or other mobile data network, or Worldwide Interoperability for Microwave Access (WIMAX).

Stored in the memory area 404 are, for example, computer readable instructions for providing a user interface to the user 34 via the media output component 406 and, optionally, receiving and processing input from the input device 408. A user interface may include, among other possibilities, a web browser and a client application. Web browsers enable users, such as authorized user 34, to display and interact with media and other information typically embedded in remote applications, web pages, or websites.

Given the components of the payment network system 10 described above, embodiments of the present invention are configured to allow an investigator, who may be in possession of one or more acquired payment cards, to efficiently obtain additional information regarding these cards. As previously noted, investigators previously had to look to multiple sources to acquire any non-visible account information regarding a payment card, which could take hours or days. To combat such scenarios, embodiments of the present invention, and particularly the PCV module 28, is specially configured to aggregate any non-visible payment account data at an aggregated data storage site, analyze and verify the visible verification data from the payment card(s) provided by the investigator, and provide the aggregated payment account data associated with the payment card(s) to the investigator if the visible verification data corresponds to a viable payment account.

If the PCV module 28 determines that the visible verification data submitted by the investigator 22 does not match a valid payment account, the interchange network 16 may send an invalid message to the investigator 2 indicating that provided visible verification data is not associated with any viable or active payment account. Alternatively, if the PCV module 28 determines that the visible verification data submitted by the investigator 22 matches a valid payment account, the interchange network 16 may send the aggregated payment account data from the aggregated data storage site to the investigator 22.

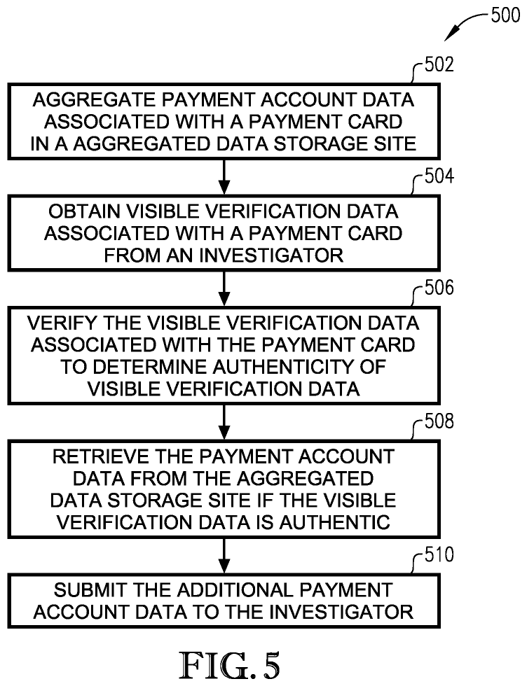

FIG. 5 depicts a flow chart of an exemplary computer-implemented method 500 for verifying the current status of a possessed payment card by an investigator. In this exemplary embodiment, the method 500 may be implemented by the PCV module, which was described above.

As shown in FIG. 5, the method 500 begins by aggregating 502 payment account data associated with a payment card in an aggregated data storage site. As noted above, the PCV module may aggregate this payment account data and store it at the aggregated data storage site. As noted above, the payment account data that can be aggregated at the aggregated data storage site may comprise recent financial transaction data associated with the payment card, legal status data of the payment card, breach analysis data of the payment card, common device data associated with the payment card, and/or recent device data associated with the payment card.

In various embodiments, the PCV module can periodically retrieve updated payment account data from the merchants, acquirers, and issuers regarding the payment card in order to ensure that the aggregated payment account data stored at the aggregated data storage site is up-to-date. For example, the aggregated data storage site may be updated periodically, such as 1, 2, 3, 4, or 5 separate times a day.

In certain embodiments, the PCV module may obtain the recent financial transaction data associated with the payment card from a Historical Authorization Database located on the interchange network. Likewise, in other embodiments, the PCV module may obtain the legal status data of the payment card from a Lost and Stolen Database located on the interchange network. In other embodiments, the PCV module may obtain the breach analysis data of the payment card from an Account Data Compromise Database located on the interchange network. Furthermore, in additional embodiments, the PCV module may obtain the common device data associated with the payment card and/or the recent device data associated with the payment card from a PAN/Device Historical Database located on the interchange network.

Although the method 500 in FIG. 5 depicts the aggregating 502 step occurring before any of the other steps, this aggregating 502 step can occur simultaneously with or after the obtaining 504 and/or verifying 506 steps in alternative embodiments. In certain embodiments, the aggregating 502 step occurs before the obtaining 504 and verifying 506 steps.

Next, the method 500 involves obtaining 504 visible verification data associated with a possessed payment card from an investigator, who inputs the data into an API application connected to the interchange network. As noted above, the visible verification data provided by the investigator can comprise a card number associated with the payment card, an expiration date associated with the payment card, and/or a CVC associated with the payment card.

An example of the obtaining 504 step could involve a police officer inputting the visible verification data of a recovered payment card (e.g., the listed card number, expiration date, and CVC code on the payment card). TABLE 1, below, depicts an exemplary input for the visible verification data that the investigator may input into the API application.

TABLE 1
Visible Verification Data Input

| | |
|---|---|
| Card Number | 5555-555-5555-1234 |
| Expiration Date | December 2021 |
| CVC Code | 123 |

The investigator inputting the data may be any person or entity that is in possession of the payment card and is looking to obtain additional information on the payment card beyond the visible verification data on the payment card. The investigator may include, for example, a merchant or a government official, such as a police officer. In certain embodiments, in order to deter fraudulent and criminal activities, the investigator must first complete a background check in order to have access to the API application. Thus, in such embodiments, only certified individuals can utilize the API application for investigation purposes. This certification process may deter fraudulent and criminal use of the API application. In one or more embodiments, the investigator must first sign into the API application in order to be certified by the PCV module as a verified and acceptable user of the application.

Next, the visible verification data provided by the investigator can be subjected to a verification 506 step, in which the PCV module may obtain the visible verification data and verify whether the visible verification data is associated with a valid and real payment account. If the visible verification data is verified and deemed authentic, then the PCV module may submit the payment account data to the investigator in possession of the payment card. If the visible verification data is not deemed authentic and is not linked to an actual account, then the PCV module may notify the investigator via the API application that the payment card in possession of the investigator is not valid.

During the verification 506 step, the PCV module can analyze and verify each component of the visible verification data provided by the investigator. For instance, the PCV module can check the inputted card number with a Network Account Range Database associated with the interchange network in order to confirm that the card number is valid and corresponds to an active payment account. Likewise, the PCV module can check with a Network Account Updater Database controlled by the issuer in order to verify that the CVC code and/or the expiration date listed on the payment card are authentic and associated with a valid payment account.

In the event that the PCV module determines that the visible verification data corresponds to a valid payment card, then the PCV module may retrieve 508 the aggregated payment account data from the aggregated data storage site.

After retrieving the aggregated payment account data from the aggregated data storage site, the PCV module may then submit 510 the aggregated payment account data to the investigator. As noted above, this aggregated payment account data provides the investigator with additional information on the payment card they possess, particularly information that is not readily available from the physical card.

The aggregated payment account data may be submitted as an output by the PCV module via the API application. TABLE 2, below, depicts an exemplary output for the API application.

TABLE 2
API Application Output of Payment Account Data

| | |
|---|---|
| Valid Card Number | Yes |
| Valid Expiration Date | Yes |
| Valid CVC | Yes |
| Most Recent Financial | Starbucks (Troy, IL) - Jan. 18, 2018 |
| Transactions | Taco Bell (Troy, IL) - Jan. 18, 2018 |
| | Frank′s BBQ (Austin, TX) - Mar. 11, 2018 |
| | YOLO Weight Loss Services (Austin TX) - |
| | Mar. 12, 2018 |
| | Tiffany & Co. (New York, NY) - Mar. 12, 2018 |
| Lost or Stolen | Yes - Mar. 13, 2018 |
| Part of Data Breach | No |
| Frequent Device Used | Apple iPhone 5 (ID 123456789) |
| with Card | |
| Most Recent Device | Jitterbug ID 7896AS |
| Used with Card | |

Upon receiving the aggregated payment account data, the investigator may conduct further investigations regarding the possessed payment card. For example, if the investigator is a merchant, they can decide to decline any financial transactions being carried out with the payment card. Alternatively, if the investigator is a police officer, they can use this new information to enhance their investigation regarding any criminal activity involving the possessed card.

It is noted that the computer-implemented method 500 may include more, fewer, or alternative operations, including those discussed elsewhere herein. Furthermore, any steps, actions, functions, operations, and the like recited herein may be performed in the order shown in the figures and/or described above, or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present invention.

A computer-readable storage media or medium comprising a non-transitory medium may include an executable computer program stored thereon. The computer program preferably instructs one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

### DEFINITIONS

It should be understood that the following is not intended to be an exclusive list of defined terms. Other definitions may be provided in the foregoing description, such as, for example, when accompanying the use of a defined term in context.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are illustrative only and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above described memory types are examples only, and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory” “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, operation, etc. described in one embodiment may also be included in other embodiments, but is not necessarily included. Thus, particular implementations of the present invention can include a variety of combinations and/or integrations of the embodiments described herein.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### Claims not Limited to Disclosed Embodiments

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A computer-implemented method for authenticating a current status of a payment card, the method comprising the steps of:
(a) aggregating payment account data associated with the payment card in an aggregated data storage site, wherein the payment account data comprises at least three data types selected from the group consisting of recent financial transaction data associated with the payment card, legal status data of the payment card, breach analysis data of the payment card, common device data associated with the payment card, and recent device data associated with the payment card;
(b) obtaining visible verification data associated with the payment card from an investigator;
(c) verifying the visible verification data associated with the payment card;
(d) retrieving the payment account data from the aggregated data storage site; and
(e) submitting the payment account data to the investigator.

2. The computer-implemented method of claim 1, further comprising periodically updating the payment account data stored in the aggregated data storage site.

3. The computer-implemented method of claim 1, wherein the aggregating of step (a) occurs before the obtaining of step (b).

4. The computer-implemented method of claim 1, wherein the visible verification data comprises a card number listed on the payment card, an expiration date listed on the payment card, and a card verification code (CVC) listed on the payment card.

5. The computer-implemented method of claim 4, wherein the payment account data comprises recent financial transaction data associated with the payment card, legal status data of the payment card, breach analysis data of the payment card, common device data associated with the payment card, and recent device data associated with the payment card.

6. The computer-implemented method of claim 5, wherein the recent financial transaction data associated with the payment card provides a listing of at least the last 2 financial transactions involving the payment card.

7. The computer-implemented method of claim 1, further comprising subjecting the investigator to a certification process prior to the obtaining of step (b).

8. A payment card verification system for a payment network, the payment card verification system comprising:
(a) a memory device for storing data; and
(b) a processor communicatively coupled to the memory device, wherein the processor may be programmed to:
(i) aggregate payment account data associated with a payment card in an aggregated data storage site, wherein the payment account data comprises at least three data types selected from the group consisting of recent financial transaction data associated with the payment card, legal status data of the payment card, breach analysis data of the payment card, common device data associated with the payment card, and recent device data associated with the payment card;
(ii) obtain visible verification data associated with the payment card from an investigator;
(iii) verify the visible verification data associated with the payment card;
(iv) retrieve the payment account data from the aggregated data storage site; and
(v) submit the payment account data to the investigator.

9. The payment card verification system of claim 8, wherein the processor is further programmed to periodically update the payment account data stored in the aggregated data storage site.

10. The payment card verification system of claim 8, wherein the aggregate of function (i) occurs prior to the obtain of function (ii).

11. The payment card verification system of claim 8, wherein the visible verification data comprises a card number listed on the payment card, an expiration date listed on the payment card, and a card verification code (CVC) listed on the payment card.

12. The payment card verification system of claim 11, wherein the payment account data comprises recent financial transaction data associated with the payment card, legal status data of the payment card, breach analysis data of the payment card, common device data associated with the payment card, and recent device data associated with the payment card.

13. The payment card verification system of claim 12, wherein the recent financial transaction data associated with the payment card provides a listing of at least the last 2 financial transactions involving the payment card.

14. The payment card verification system of claim 8, wherein the processor is further programmed to confirm the identity of the investigator.

15. A non-transitory computer-readable storage media having computer-executable instructions for verifying a payment card stored thereon, when executed by at least one processor, the computer-executable instructions cause the processor to:
(a) aggregate payment account data associated with the payment card in an aggregated data storage site, wherein the payment account data comprises at least three data types selected from the group consisting of recent financial transaction data associated with the payment card, legal status data of the payment card, breach analysis data of the payment card, common device data associated with the payment card, and recent device data associated with the payment card;
(b) obtain visible verification data associated with the payment card from an investigator;
(c) verify the visible verification data associated with the payment card;
(d) retrieve the payment account data from the aggregated data storage site; and
(e) submit the payment account data to the investigator.

16. The non-transitory computer-readable storage media of claim 15, wherein the computer-executable instructions further cause the processor to periodically update the payment account data stored in the aggregated data storage site.

17. The non-transitory computer-readable storage media of claim 15, wherein the visible verification data comprises a card number listed on the payment card, an expiration date listed on the payment card, and a card verification code (CVC) listed on the payment card.

18. The non-transitory computer-readable storage media of claim 15, wherein the payment account data comprises recent financial transaction data associated with the payment card, legal status data of the payment card, breach analysis data of the payment card, common device data associated with the payment card, and recent device data associated with the payment card.

19. The non-transitory computer-readable storage media of claim 18, wherein the recent financial transaction data associated with the payment card provides a listing of at least the last 2 financial transactions involving the payment card.

20. The non-transitory computer-readable storage media of claim 15, wherein the computer-executable instructions further cause the processor to confirm the identity of the investigator.
